(19) United States
(12) Patent Application Publication
(10) Pub. No.: US 2006/0157086 A1
(43) Pub. Date: Jul. 20, 2006

(54) Apparatus and method for dispensing fluid

(75) Inventors: Jerrod Aaron Kappler, Louisville, KY (US); Joseph Duane Tobbe, Taylorsville, KY (US); Paul Douglas Mantle, Louisville, KY (US); Shelly Elizabeth Warms, Louisville, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/038,869

(22) Filed: Jan. 20, 2005

(51) Int. Cl. B08B 3/00; B08B 3/12

(52) U.S. Cl. 134/34; 134/56 D; 134/58 D; 134/184

(57) ABSTRACT

A method of dispensing a fluid into a washing device including a wash chamber. The method includes positioning a fluid dispensing system within a door assembly including an outer wall, an inner wall, and a cavity defined therebetween. The inner wall includes an outer surface and an inner surface, wherein the fluid dispensing system is fixedly coupled to the inner wall and/or the outer wall. The method further includes determining an amount of fluid to dispense and pumping the determined amount of fluid within the wash chamber.

### BACKGROUND OF THE INVENTION

This invention relates generally to dishwashers, and more particularly, to detergent dispensers for dishwashers.

At least some known dishwashers include a cabinet, a tub within the cabinet that defines an open sided wash chamber, and a door assembly that seals the open side of the wash chamber when the dishwasher is in use. Soiled dishes, glasses, utensils, food and beverage containers, etc. are loaded into the dishwasher tub through the open side of the wash chamber when the door is open, and after the door is closed, a dishwasher cycle is executed to clean the items placed therein. The wash chamber includes a sump portion that pumps washing fluid from a fluid circulation assembly through spray arm conduits to wash items loaded onto dishwasher racks in the wash chamber, and also collects wash fluid after it has circulated throughout the wash chamber. The door assembly is attached to the dishwasher at a bottom end of the door and pivots about a hinge between fully open and fully closed positions.

Some known dishwashers include a detergent dispenser attached to an inner portion of the door assembly. The detergent dispenser includes a trough and a hinged lid or cover that closes the trough and prevents solid or powdered detergent therein from contacting moisture until a designated time in a wash cycle. At a point in time, the cover is opened and the detergent in the reservoir is released. To facilitate removal of all of the detergent from the dispenser, or to more quickly release detergent from the dispenser, a water spray jet may be directed into the trough to clear detergent from the dispenser trough. However, the detergent dispenser is refilled between each dishwasher use by an operator, thereby adding additional steps and time. In addition, consistently and accurately filling the dispenser trough according to the selected wash cycle can be challenging. If too little detergent is added, wash cycle efficiency and effectiveness is decreased. If too much detergent is added, the additional detergent may be wasted or increase the risk of etching or spots.

Additionally, some known dishwashers include a detergent tank removeably attached to the door assembly. The detergent tank is coupled to a detergent dispenser that includes a trough and a hinged lid or cover that closes the trough and prevents the detergent therein from contacting moisture until a designated time in a wash cycle. At a point in time, the cover is opened and the detergent in the reservoir is released. However, the detergent tank must be removed in order to refill, thereby adding additional steps and time. In addition, consistently and accurately dispensing the correct amount of detergent based on the state of the dishes, hardness of the water, and water temperature may be challenging. The correct amount of detergent has a direct effect on the wash cycle efficiency and effectiveness.

### BRIEF DESCRIPTION OF THE INVENTION

In one aspect, a method of dispensing a fluid into a washing device including a wash chamber is provided. The method includes positioning a fluid dispensing system within a door assembly including an outer wall, an inner wall, and a cavity defined therebetween. The inner wall includes an outer surface and an inner surface, wherein the fluid dispensing system is fixedly coupled to the inner wall and/or the outer wall. The method further includes determining an amount of fluid to dispense and pumping the determined amount of fluid within the wash chamber.

In another aspect, a fluid dispensing system for a dishwasher door assembly is provided. The system includes at least one storage tank fixedly coupled within the door assembly, at least one pump fixedly coupled within the door assembly, and at least one dispenser extending at least partially through the door assembly. The system also includes at least one conduit in flow communication with the tank, the pump, and the dispenser and a control board in electrical communication the storage tank and the pump.

In another aspect, a dishwasher is provided. The dishwasher includes a cabinet that includes a tub having a front opening and a door assembly forming a wash chamber. The door assembly includes an outer door panel, an inner door panel, and a plurality of sidewalls extending therebetween. The dishwasher includes at least one fluid dispensing system in flow communication with the wash chamber. The system includes at least one storage tank fixedly coupled within the door assembly, at least one peristaltic pump fixedly coupled within the door assembly, at least one dispenser extending at least partially through the inner door panel. The system also includes at least one flexible conduit removeably coupled to the door assembly and in flow communication with the tank, the pump, and the dispenser, and a control board in electrical communication the storage tank and the pump.

### BRIEF DESCRIPTION OF THE DRAWINGS

FIG. 1 is a side elevational view of an exemplary dishwasher partially broken away.

FIG. 2 is a perspective exploded view of a dishwasher door assembly including a fluid dispensing system for the dishwasher shown in FIG. 1.

FIG. 3 is a top perspective view of the fluid dispensing system shown in FIG. 2.

FIG. 4 is a rear perspective view of the fluid dispensing system shown in FIG. 2.

### DETAILED DESCRIPTION OF THE INVENTION

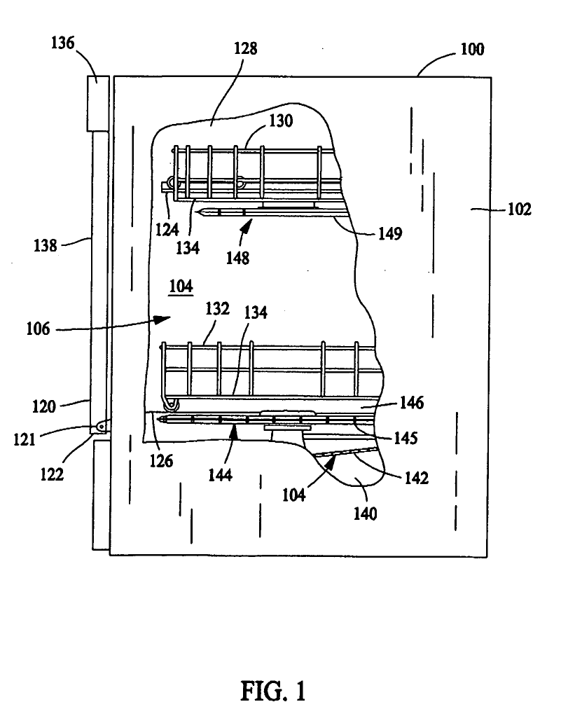

FIG. 1 is a side elevational view of an exemplary domestic dishwasher system 100 partially broken away. It is contemplated, however, that the methods and apparatus herein described may be practiced in other types of dishwashers and dishwasher systems beyond dishwasher system 100 described and illustrated herein. Moreover, the methods and apparatus herein described may find utility in other applications wherein dispensers in wet environments are desirable. Accordingly, the following description is for illustrative purposes only, and the methods and apparatus herein described is in no way limited to use in a particular application, or to a particular type of appliance, such as, for example, dishwasher system 100.

Dishwasher 100 includes a cabinet 102 having a tub 104 therein and forming a wash chamber 106. Tub 104 includes a front opening (not shown in FIG. 1) and a door assembly 120 pivotally attached by a hinge 121 at a bottom 122 for movement between a normally closed vertical position (shown in FIG. 1) wherein wash chamber 106 is sealed shut for washing operation, and a horizontal open position (not shown) for loading and unloading of dishwasher contents. An upper guide rail 124 and a lower guide rail 126 are mounted on tub side walls 128 and accommodate an upper roller-equipped rack 130 and a lower roller-equipped rack 132. Each of upper and lower racks 130, 132 is fabricated from known materials into lattice structures including a plurality of elongate members 134, and each rack 130, 132 is adapted for movement between an extended loading position (not shown) in which the rack is substantially positioned outside wash chamber 106, and a retracted position (shown in FIG. 1) in which the rack is located inside wash chamber 106. A silverware basket (not shown) is removably attached to lower rack 132 for placement of silverware, utensils, and the like that are too small to be accommodated by upper and lower racks 130, 132.

A control panel (not shown in FIG. 1) is integrated into an escutcheon 136 that is mounted to door assembly 120, or in further and/or alternative embodiments, a plurality of control selectors, (e.g., buttons, switches or knobs) or control displays etc. may be mounted at a convenient location on an outer face 138 of door assembly 120. The control panel and associated selectors and displays are coupled to known control circuitry (not shown) and control mechanisms (not shown) for operating a fluid circulation assembly (not shown) that circulates water and dishwasher fluid in dishwasher tub 104. The fluid circulation assembly is located in a machinery compartment 140 located below a bottom sump portion 142 of tub 104. The construction and operation of the fluid circulation assembly is well within the purview of those in the art without detailed explanation, and further discussion of the fluid circulation assembly is therefore omitted.

A lower spray-arm-assembly 144 is rotatably mounted within a lower region 146 of wash chamber 106 and above tub sump portion 142 so as to rotate in relatively close proximity to lower rack 132. A mid-level spray-arm assembly 148 is located in an upper region of wash chamber 106 and is located in close proximity to upper rack 130 and at a sufficient height above lower rack 132 to accommodate a larger item, such as a dish or platter (not shown), that can be placed in lower rack 132 and washed in dishwasher system 100. In another embodiment, an upper spray arm assembly (not shown) is located above upper rack 130 at a sufficient height to accommodate a taller item that can be placed in upper rack 130, such as a glass (not shown) of a selected height.

Lower and mid-level spray-arm assemblies 144, 148 and the upper spray arm assembly are fed by the fluid circulation assembly, and each spray-arm assembly includes an arrangement of discharge ports or orifices 145, 149, respectively, for directing washing liquid onto dishes located in upper and lower racks 130, 132, respectively. The arrangement of discharge ports 145 in at least lower spray-arm assembly 144 provides a rotational force by virtue of washing fluid flowing through discharge ports 145. The resultant rotation of lower spray-arm assembly 144 provides coverage of dishes and other dishwasher contents with a washing spray. In various alternative embodiments, mid-level spray arm 148 and/or the upper spray arm are also rotatably mounted and configured to generate a swirling spray pattern above and below upper rack 130 when the fluid circulation assembly is activated and door assembly 120 is properly closed to seal wash chamber 106 for operation.

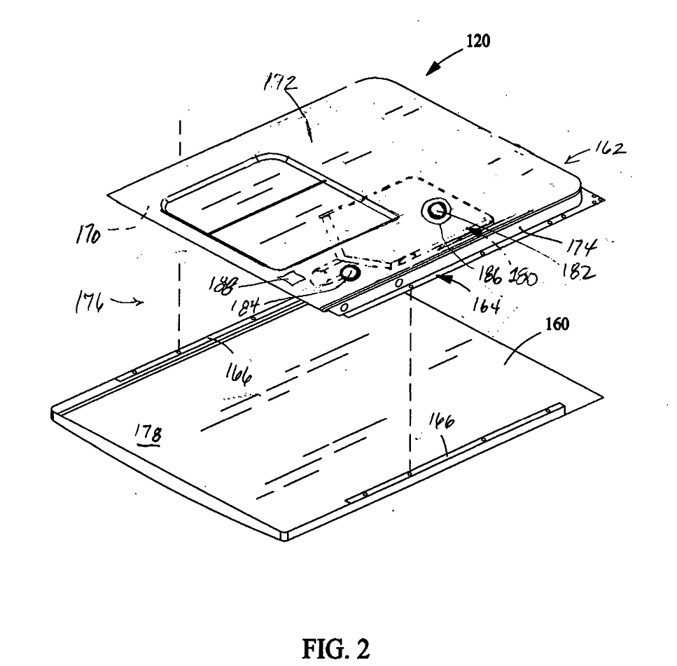

FIG. 2 is an exploded perspective view of dishwasher door assembly 120. Door assembly 120 may be used, for example, with dishwasher 100 (shown in FIG. 1). In the exemplary embodiment, door assembly 120 includes an outer door panel 160 and an inner door panel 162. It is noted that exemplary inner door panel 162 and outer door panel 160 are intended for illustrative purposes only, and that the herein described invention may be used with differently configured inner and/or outer door panels than illustrated, as well as a plurality of intermediate door panels (not shown) positioned between outer door panel 160 and inner door panel 162.

In the exemplary embodiment, inner door panel 162 is attached to outer door panel 160 via a plurality of attachment flanges 164 on an outer perimeter of inner door panel 162 that are fastened to a plurality of attachment flanges 166 in outer door panel 160. In the exemplary embodiment, inner door panel 162 includes an inner surface 170, an outer surface 172, a plurality of sidewalls 174 extending therebetween, and a cavity 176 defined therein. Cavity 176 may have a variety of shapes and sizes to facilitate permanently positioning a fluid dispensing system 180 therein and adjacent inner surface 170.

It is contemplated that fluid dispensing system 180, as explained further below, is permanently located within door assembly 120. In the exemplary embodiment, system 180 is permanently attached to inner surface 170. In an alternative embodiment, system 180 is attached to an inner surface 178 of outer door panel 160.

In the exemplary embodiment, fluid dispensing system 180 is a detergent dispensing system configured to dispense commercially available dishwashing detergent. In one embodiment, system 180 dispenses a rinse agent. In alternative embodiments, system 180 is configured to dispense any other suitable fluid that enables system 180 to function as described herein.

Door panel 162 includes a refill inlet 182 and a detergent outlet 184 both extending at least partially through door panel 162 and in flow communication with system 180. Inlet 182 facilitates the addition of detergent to system 180 and outlet 184 facilitates the delivery of detergent to the wash chamber. In the exemplary embodiment, inlet 182 and outlet 184 may be fabricated by a molding process. Alternatively, inlet 182 and outlet 184 may be fabricated by other processes, such as, but not limited to, a forming process, a milling process, or a grinding process. In the exemplary embodiment, a sealing cap 186 is non-removeably coupled to inlet 182. In an alternative embodiment, cap 186 is removable. In one embodiment, an appliance control module (not shown) and a latch assembly (not shown) are positioned within door assembly 120 as those in the art will appreciate.

In the exemplary embodiment, door panel 162 further includes a sensor 188 extending outwardly from outer surface 172. In the exemplary embodiment, sensor 188 is at least one of a temperature sensor, thermostat, a turbidity sensor, and a hardness sensor. Alternatively, sensor 188 includes three separate sensors selected from the group of sensors, such as, but not limited to, sensors configured to determine the soil level of the dishes, the temperature of the water, and the hardness of the water.

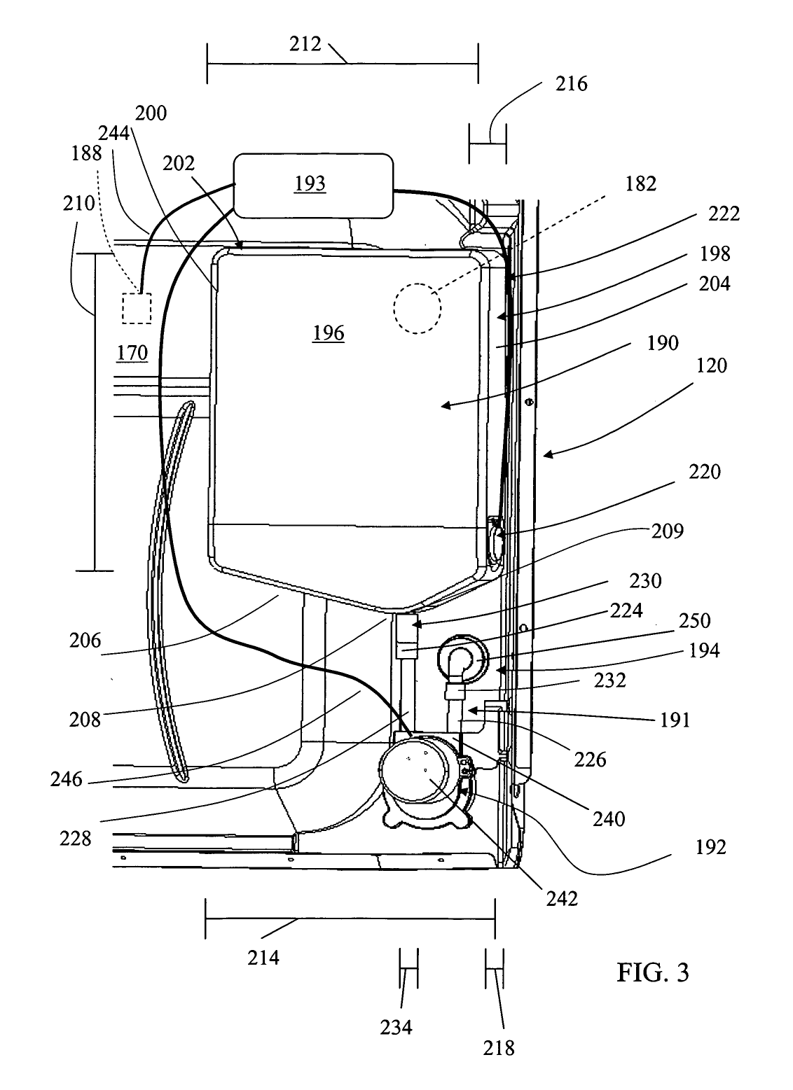

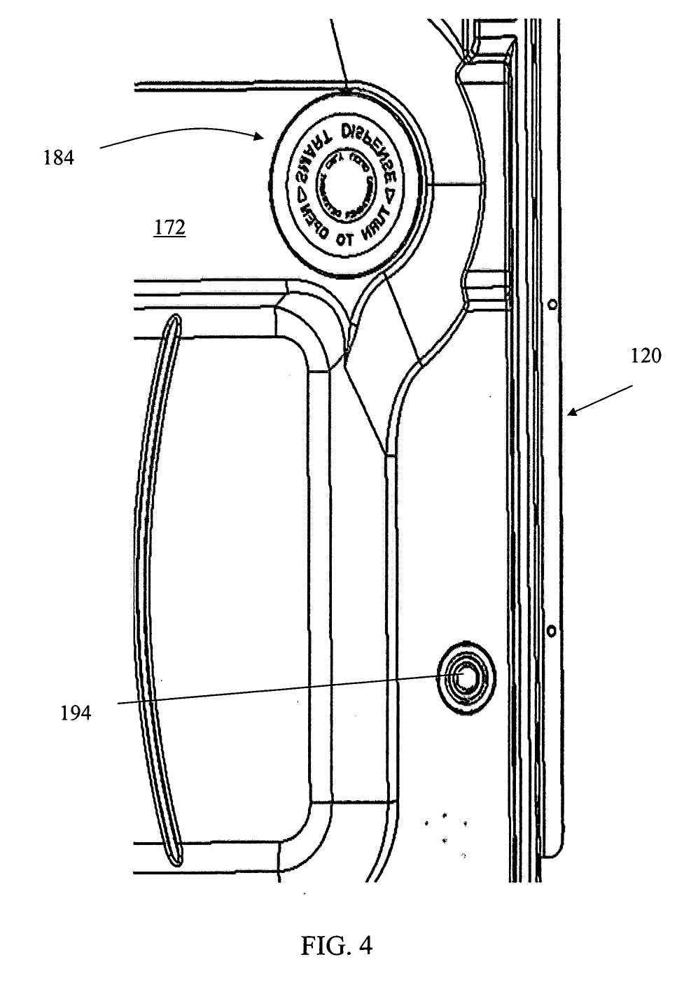

FIG. 3 is a top perspective view of fluid dispensing system 180. FIG. 4 is back perspective view of fluid dispensing system 180. In the exemplary embodiment, delivery system 168 includes a reservoir or a storage tank 190, a conduit 191, a pump 192, a control board 193, and a dispenser 194 all in flow communication with one another. In the exemplary embodiment, tank 190 is pentagonal in shape. In alternative embodiments, tank 190 has other shapes, such as but not limited to, a triangular shape, and a curvilinear shape. In the exemplary embodiment, tank 190 is unitary and fabricated from a molded polyethylene material. In alternative embodiments, tank 190 is fabricated from any other suitable material that enables tank 190 to function as described herein, such as a clear material. In the exemplary embodiment, tank 190 is fabricated by a molding process. Alternatively, tank 190 is fabricated by other processes, such as, but not limited to, a forming process, a milling process, or a grinding process. In alternative embodiments, a plurality of tanks 190 are included, such as, a detergent tank and a rinse agent tank (not shown).

In the exemplary embodiment, tank 190 includes a top surface 196, a bottom surface (not shown), and a plurality of sidewalls 198 extending therebetween. Specifically, in the exemplary embodiment, tank 190 includes a first sidewall 200, a second sidewall 202, a third sidewall 204, and a fourth sidewall 206. First and third sidewalls 200 and 204 are substantially parallel to one another and second and fourth sidewalls 202 and 206 are substantially not parallel to one another. As such, first and third sidewalls 200 and 204 are perpendicular to second sidewall 202.

Fourth sidewall 206 includes an arcuate portion 208 positioned therebetween. In the exemplary embodiment, arcuate portion 208 is positioned proximate third sidewall 204. In another embodiment, arcuate portion 208 is positioned proximate second sidewall 202. In the exemplary embodiment, arcuate portion 208 includes an outlet 209 extending therethrough and is in flow communication with conduit 191. In the exemplary embodiment, outlet 209 is fabricated by a molding process. Alternatively, outlet 209 is fabricated by other processes, such as, but not limited to, a forming process, a milling process, or a grinding process.

First and third sidewalls 200 and 204 have a first length 210, second sidewall 202 has a second length 212, and fourth sidewall 206 has a third length 214. In the exemplary embodiment, lengths 210, 212, and 214 are all different. Specifically, in the exemplary embodiment, lengths 212 and 214 are less than length 210 and length 212 is less than length 214. Alternatively, lengths 210, 212, and 214 may be selected to be any length. Additionally, sidewall 202 has a first height 216 and fourth sidewall 206 has a second height 218. In the exemplary embodiment, heights 216 and 218 are different. Specifically, height 216 is greater than height 218. As such, first and third sidewalls generally taper towards fourth sidewall 206. In alternative embodiments, lengths 210, 212, and 214 and/or height 216 may be longer or shorter than the above indicated lengths and heights, depending upon the particular application.

In the exemplary embodiment, the tank bottom surface is fixedly coupled to inner door panel inner surface 170 such that tank 190 is permanently attached to inner surface 170. In an alternative embodiment, tank 190 is permanently attached to an intermediate structure (not shown) within door assembly 120. In the exemplary embodiment, tank 190 is fixedly coupled to inner surface 170 by a plurality of fasteners. Alternatively, tank 190 is fixedly coupled to inner surface 170 by a plurality of mechanical fasteners, such as, but not limited to, snap-fit fasteners or other known locking or latching fasteners, or chemical fasteners, such as an adhesive. Alternatively, tank 190 is molded within door assembly 120.

In the exemplary embodiment, tank sidewall 204 includes a fluid sensor 220 extending therein and in electrical communication with control board 193. In the exemplary embodiment, sensor 220 is coupled to third sidewall 204 adjacent fourth sidewall 206. In alternative embodiments, sensor 220 is positioned anywhere on or in tank 190. In the exemplary embodiment, sensor 220 is configured to determine whether fluid is present in tank 190 and generate a signal to control board 193 along a wire 222. In an alternative embodiment, sensor 220 is a stand alone sensor not in electrical communication with control board 193. In alternative embodiments, sensor 220 may be any sensor configured to detect the presence or non-presence of fluid.

In the exemplary embodiment, tank conduit 191 is flexible and cylindrical in shape. In one embodiment, conduit 191 is a one-piece tube or hose fabricated from a molded polymer material. In alternative embodiments, conduit 191 is fabricated from any other suitable elastic or rubber material, such as silicone rubber or Autoprene® (commercially available from Monsanto Corporation, St. Louis, Mo.) that enables conduit 191 to function as described herein. In alternative embodiments, conduit 191 is fabricated from a combination of flexible and/or rigid materials.

In the exemplary embodiment, conduit 191 includes a first end 224, a second end 226, and a body 228 extending therebetween. Additionally, conduit 291 includes a first connector 230 operatively coupled to outlet 209 and a second connector 232 operatively coupled to dispenser 194. As such, at least a portion of body 228 extends within pump 192. In the exemplary embodiment, connectors 230 and 232 are removeably coupled to tank outlet 209 and dispenser 194, respectively. In an alternative embodiment, tank 190, conduit 191, and dispenser 194 are one-piece. As such, conduit 191 is non-removable from tank outlet 191 and dispenser 194.

Conduit 191 has a length (not shown) and a diameter 234, wherein tube diameter 234 is equal to a tank outlet diameter (not shown) and a dispenser diameter (not shown). The length and diameter 234 are variably sized and the number of conduits chosen is relative to the location and number of tanks 190 and dispensers 194 within door assembly 120 and the size of system 180.

In the exemplary embodiment, pump 192 is a single peristaltic pump fixedly coupled within door assembly 120 and is in electrical communication with control board 193 and in mechanical communication with tank 190, conduit 191, and dispenser 194. Alternatively, a plurality of pumps 192 are fixedly coupled within door assembly to each of tank 190 and a rinse agent tank (not shown). Pump 192 is configured to facilitate pumping an optimal amount of fluid into wash chamber 106 (shown in FIG. 1) during one or more wet portions of the wash cycle based on at least one of a water temperature, a water hardness, and a soil level as determined by sensor 188 described above. The wet portion of the wash cycle includes a plurality of fills, wherein each fill includes activation of the water valve, circulation of the wash fluid, and draining of the wash chamber. In the exemplary embodiment, the wash cycle includes a pre-wash and a main wash. It is noted that the exemplary pre-wash cycle and main wash cycle are intended for illustrative purposes only, and that the herein described pump may be used with differently configured wash cycles and wet portions of the wash cycle than illustrated. It is contemplated, the pump facilitates dispensing fluid at any single time or multiple time during the operation of the dishwasher. Alternatively, pump 192 is configured to facilitate pumping an optimal amount of fluid into wash chamber 106 during a predetermined time interval determined by an electromechanical timer (not shown).

In the exemplary embodiment, pump 192 includes a pump head 240 and a drive 242. In the exemplary embodiment, pump head 240 has a plurality of rollers (not shown) wherein the number of rollers is dependent on the size of the dishwasher and the operational needs of system 180. In the exemplary embodiment, drive 242 is integral with pump 192. In one embodiment, drive 242 is a variable drive. As such, a flow rate of pump 192 is adjustable. In one embodiment, pump 192 is configured to purge the entire system 180 of fluid and/or detergent such that tank 190, conduit 191, and dispenser 194 are free of fluid. In an alternative embodiment, pump 192 is reversible and as such may be configured to flush conduit 191 and overcome potential detergent clogs.

In the exemplary embodiment, control board 193 is coupled within door assembly 120 and is in electrical communication with sensor 188 by wire 244, sensor 220 by wire 222, and pump 192 by wire 246. Control board 193 is configured to facilitate determining an optimal amount of detergent dispensed during any wet portion of a wash cycle based on at least one of a water temperature, a water hardness, and a soil level as determined by sensor 188 described above. Control board 193 may also be configured to determine the optimum level of rinse agent required during any wet portion of a wash cycle. In an alternative embodiment, control board may be in electrical communication with only pump 192. Alternatively, control board 193 may be selected from at least one of an electric device, an electromechanical device, and a mechanical device.

In the exemplary embodiment, control board 193 is configured to facilitate activating pump drive 242. Control board 193 is configured to activate pump drive 242 to dispense more detergent for dirty dishes and less detergent for cleaner dishes, to dispense more detergent for harder water and less detergent for softer water, and to dispense an optimum amount of detergent based on the water temperature, or any combination of soil level, turbidity, and temperature.

In the exemplary embodiment, dispenser 194 extends at least partially through inner door panel 162 and is coupled to both inner surface 170 and outer surface 172. Dispenser 194 is coupled in flow communication with conduit 191. Dispenser 194 includes detergent outlet 184 described above and a grommet 250. In alternative embodiments, dispenser 194 may include a one-way valve (not shown). In the exemplary embodiment, grommet 250 is fabricated from a rubber material. In alternative embodiments, grommet 250 is fabricated from any other suitable material that enables grommet 250 to function as described therein.

In operation, tank 190 is filled with a known dishwasher detergent. In one embodiment, tank 190 is filled with a plurality of detergents. In one embodiment, the detergent is a commercially available liquid dishwasher detergent or a commercially available liquid rinse agent. The detergent is directed through conduit 191 by pump 192 and out dispenser 194. When dishwasher racks 130 and 132 are loaded with items to be washed, door assembly 120 is closed, thereby sealing wash chamber 106 for operation of wash cycles. At an appropriate time during the wet portion of the wash cycle, for example, in a pre-wash or wash cycle, control board 193 receives a signal from sensor 188 and activates pump 192. Detergent is dispensed into dishwasher wash chamber 106 (shown in FIG. 1) through dispenser 194 wherein the detergent is mixed with water to produce a cleansing fluid for circulation throughout wash chamber 106.

The above described detergent dispensing system is cost-effective and highly-reliable. The system includes a detergent storage tank and a peristaltic pump permanently mounted within a dishwasher door assembly. The system is configured to determine and dispense an optimal amount of detergent into the dishwasher. Coupling the peristaltic pump and the tank within the door assembly allows for greater detergent storage capacity and minimizes potential leaks. As such, users fill the detergent dispensing system less often, which reduces the amount of time and steps in compared to conventional dishwasher systems. Additionally, dispensing the optimal amount of detergent facilitates improving dishwasher performance and user satisfaction.

While the invention has been described in terms of various specific embodiments, those skilled in the art will recognize that the invention can be practiced with modification within the spirit and scope of the claims.

What is claimed is:

1. A method of dispensing a fluid into a washing device including a wash chamber, said method comprising:
positioning a fluid dispensing system within a door assembly including an inner wall, an outer wall, and a cavity defined therebetween, the inner wall includes an outer surface and an inner surface, wherein the fluid dispensing system is fixedly coupled to the inner wall and/or outer wall;
determining an amount of fluid to dispense; and
pumping the determined amount of fluid within the wash chamber.

2. A method in accordance with claim 1 wherein positioning a fluid dispensing system further comprises fixedly coupling at least one storage tank to the inner wall inner surface, fixedly coupling at least one pump to the inner wall inner surface, and positioning at least one dispenser at least partially through the inner wall inner surface.

3. A method in accordance with claim 2 wherein positioning a fluid dispensing system further comprises coupling at least one flexible conduit in flow communication with the tank, the pump, and the dispenser.

4. A method in accordance with claim 1 wherein determining an amount of fluid further comprises determining an optimal amount of fluid dispensed during a wash cycle based on at least one of a water temperature, a water hardness, and a soil level.

5. A method in accordance with claim 1 wherein determining an amount of fluid further comprises coupling at least one of a turbidity sensor, a temperature sensor, and a hardness sensor to the fluid dispensing system.

6. A method in accordance with claim 1 wherein pumping the determined amount of fluid further comprises pumping the determined amount of fluid during a wet portion of a wash cycle, wherein the pump is a peristaltic pump in electrical communication with a control board.

7. A method in accordance with claim 1 wherein pumping the determined amount of fluid within the wash chamber further comprises pumping the determined amount of fluid through the dispenser and the conduit.

8. A fluid dispensing system for a dishwasher door assembly, said system comprising:
at least one storage tank fixedly coupled within the door assembly;
at least one pump fixedly coupled within the door assembly;
at least one dispenser extending at least partially through the door assembly;
at least one conduit in flow communication with said tank, said pump, and said dispenser; and
a control board in electrical communication said pump.

9. A system in accordance with claim 8 wherein said storage tank is unitary and comprises a first surface, a second surface, and a plurality of sidewalls extending therebetween, said first surface fixedly coupled to an inner portion of the door assembly.

10. A system in accordance with claim 8 wherein said storage tank is tapered and comprises an inlet formed therein, at least one sensor coupled thereto, and an outlet coupled to said conduit, said at least one sensor in electrical communication with said control board and comprising at least one of a turbidity sensor, a thermal sensor, and a hardness sensor.

11. A system in accordance with claim 8 wherein said pump comprises a peristaltic pump, said peristaltic pump configured to be fixedly coupled to an inner portion of the door assembly.

12. A system in accordance with claim 8 wherein said pump configured to be activated by said control board during a wet portion of a wash cycle, said pump further configured to deliver a set amount of fluid into a dishwasher from said tank.

13. A system in accordance with claim 8 wherein said dispenser comprises a grommet comprising at least one of a rubber material, a plastic material, and a metal material, said grommet in flow communication with said conduit and the door assembly.

14. A system in accordance with claim 8 wherein said conduit is flexible and removeably coupled to said dispenser and a tapered portion of said tank, said conduit extends between said tank and said dispenser such that at least a portion of said conduit is positioned within said pump.

15. A dishwasher comprising:
a cabinet comprising a tub having a front opening and a door assembly forming a wash chamber, said door assembly comprising an outer door panel, an inner door panel, and a plurality of sidewalls extending therebetween;
at least one fluid dispensing system, said system in flow communication with said wash chamber, said system comprising:
at least one tapered storage tank fixedly coupled within said door assembly;
at least one peristaltic pump fixedly coupled within said door assembly;
at least one dispenser extending at least partially through said inner door panel; and
at least one flexible conduit removeably coupled to said door assembly and in flow communication with said tank, said pump, and said dispenser; and
a control board in electrical communication with said pump.

16. A dishwasher in accordance with claim 15 wherein said storage tank is unitary and comprises a first surface, a second surface, and a plurality of sidewalls extending therebetween, said first surface fixedly coupled to said inner door panel, said tank further comprises an inlet formed therein, at least one sensor coupled thereto, and an outlet coupled to said conduit, said at least one sensor in electrical communication with said control board and comprising at least one of a turbidity sensor, a temperature sensor, and a hardness sensor.

17. A dishwasher in accordance with claim 15 wherein said peristaltic pump configured to be fixedly coupled to said inner door panel, said pump configured to be activated by said control board during a wet portion of a wash cycle, said pump further configured to deliver a set amount of fluid into said wash chamber.

18. A dishwasher in accordance with claim 15 wherein said dispenser comprises a grommet comprising at least one of a rubber material, a plastic material, and a metal material, said grommet in flow communication with said conduit and the door assembly.

19. A dishwasher in accordance with claim 15 wherein said conduit is removeably coupled to said dispenser and a tapered portion of said tank, said conduit extends between said tank and said dispenser such that at least a portion of said conduit is positioned within said pump.

20. A dishwasher in accordance with claim 15 wherein said control board is configured to determine an optimal amount of fluid dispensed per wash cycle based on at least one of a water temperature, a water hardness, and a soil level.
